(19) United States
(12) Patent Application Publication
(10) Pub. No.: US 2020/0369282 A1
(43) Pub. Date: Nov. 26, 2020

(54) DRIVER STATE DETERMINATION APPARATUS, DRIVER STATE DETERMINATION METHOD, AND NON-TRANSITORY COMPUTER-READABLE MEDIUM

(71) Applicants: Keisuke Yokota, Aichi (JP); Yoshio Matsuura, Aichi (JP); Kazuki Miura, Aichi (JP)

(72) Inventors: Keisuke Yokota, Aichi (JP); Yoshio Matsuura, Aichi (JP); Kazuki Miura, Aichi (JP)

(73) Assignee: NIDEC MOBILITY CORPORATION, Aichi (JP)

(21) Appl. No.: 16/881,080

(22) Filed: May 22, 2020

(30) Foreign Application Priority Data
May 24, 2019 (JP) 2019-097931

(51) Int. Cl. B60W 40/08; B60W 40/10; B60W 50/14; G06K 9/00

(52) U.S. Cl. CPC B60W 40/08; B60W 40/10; B60W 50/14; B60W 40/107; B60W 2040/0818; B60W 2420/42; G06K 9/00845

(57) ABSTRACT

A driver state determination apparatus includes: a vehicle behavior information acquisition unit that acquires behavior information of a vehicle; an image information acquisition unit that acquires image information including a face of a driver; a reference value setting unit that sets a reference value based on the behavior information of the vehicle acquired by the vehicle behavior information acquisition unit; and an index value calculation unit that calculates an index value relating to a driving state of the driver using duration of a state in which an amount of change in the image information acquired by the image information acquisition unit is equal to or less than the reference value. The apparatus further includes a determination unit that determines that the driver is in an unconscious state when the index value calculated by the index value calculation unit is equal to or greater than a threshold value.

### CROSS-REFERENCES TO RELATED APPLICATIONS

This application is based upon and claims the benefit of priority from Japanese Patent Application No. 2019-097931, filed on May 24, 2019; the entire contents of which are incorporated herein by reference.

### FIELD

One or more embodiments of the present invention relate to a driver state determination apparatus, a driver state determination method, and a non-transitory computer-readable medium.

### BACKGROUND

In recent years, various devices for assisting a driver have been mounted on a vehicle in order to prevent a collision accident of the vehicle. For example, in JP-A-2000-326757, a dangerous approach prevention device that controls a braking force of the vehicle by a brake pedal operation of a driver when one's own vehicle excessively approaches a preceding vehicle is described.

In the dangerous approach prevention device of JP-A-2000-326757, it is determined whether or not the driver is unconscious, and the braking force of the vehicle is controlled only when the driver is unconscious. Specifically, by paying attention to the fact that when a driver becomes an unconscious state such as falling asleep, there is a characteristic the driver tries to suddenly correct the trajectory of the vehicle, if an amount of change of a steering wheel angle within a predetermined time is equal to or greater than a predetermined value, it is determined that the driver is in an unconscious state. With this configuration, it is possible to avoid a collision accident of the vehicle without impairing operational feeling of the driver.

### SUMMARY

However, in the dangerous approach prevention device of JP-A-2000-326757, since the unconscious state of the driver is not detected when the driver does not perform a sudden steering operation, there is room for improvement in accuracy of a unconscious state determination of the driver.

An aspect of the present invention made to solve the problem described above is to provide a driver state determination apparatus, a driver state determination method, and a driver state determination program capable of determining an unconscious state of the driver with high accuracy.

A driver state determination apparatus according to aspect 1 of the present invention includes a vehicle behavior information acquisition unit that acquires behavior information of a vehicle, an image information acquisition unit that acquires image information including a face of a driver, a reference value setting unit that sets a reference value based on the behavior information of the vehicle acquired by the vehicle behavior information acquisition unit, an index value calculation unit that calculates an index value relating to a driving state of the driver using duration of a state in which an amount of change in the image information acquired by the image information acquisition unit is equal to or less than the reference value, and a determination unit that determines that the driver is in an unconscious state when the index value calculated by the index value calculation unit is equal to or greater than a threshold value.

According to the configuration described above, after the reference value setting unit sets the reference value based on the vehicle behavior information acquired by the vehicle behavior information acquisition unit, the index value relating to the driving state of the driver is calculated by the index value calculation unit using the duration of the state in which the amount of change in the image information acquired by the image information acquisition unit is equal to or less than the reference value. Then, the determination unit determines that the driver is in an unconscious state when the index value calculated by the index value calculation unit is equal to or greater than the threshold value. As described above, by determining the unconscious state of the driver based on the duration of the state in which movement of the face of the driver or the like is equal to or less than the reference value, for example, even when the driver does not perform a sudden steering operation, the unconscious state of the driver can be detected. Furthermore, since it is determined whether or not the driver is in an unconscious state in consideration of the behavior information of the vehicle, the unconscious state of the driver can be determined with high accuracy.

In the driver state determination apparatus according to aspect 2 of the present invention, the index value calculation unit obtains, as the amount of change in the image information, a deviation or variance in each of a lateral direction, a vertical direction, and a rotation direction of the face of the driver.

According to the configuration described above, by obtaining the deviation or variance in the lateral direction, the vertical direction, and the rotation direction of the face of the driver by the index value calculation unit, the index value relating to the driving state of the driver can be accurately calculated.

In the driver state determination apparatus according to aspect 3 of the present invention, the vehicle behavior information acquisition unit acquires an acceleration in each of a front-and-rear direction, a lateral direction, and a vertical direction of the vehicle. The reference value setting unit sets the reference value to: a first reference value when the acceleration in each of the front-and-rear direction, the lateral direction, and the vertical direction of the vehicle acquired by the vehicle behavior information acquisition unit is less than a predetermined value determined for each of the accelerations in the front-and-rear direction, the lateral direction, and the vertical direction of the vehicle; and a second reference value greater than the first reference value continuously for a predetermined time when any one of the accelerations in the front-and-rear direction, the lateral direction, and the vertical direction of the vehicle acquired by the vehicle behavior information acquisition unit is equal to or greater than the predetermined value.

According to the configuration described above, the reference value setting unit sets the reference value to the first reference value or the second reference value according to whether or not the acceleration in each of the front-and-rear direction, the lateral direction of the vehicle, and the vertical direction is less than a predetermined value determined for each of the accelerations in the front-and-rear direction, the lateral direction, and the vertical direction of the vehicle. With this configuration, the duration of the state in which the amount of change in the image information is equal to or less than the reference value can be counted in consideration of a case where the direction of the face changes due to vehicle vibration, and thus the index value relating to the driving state of the driver can be accurately calculated even when the driver is in an unconscious state.

In the driver state determination apparatus according to aspect 4 of the present invention, the vehicle behavior information acquisition unit acquires an acceleration in each of a front-and-rear direction, a lateral direction, and a vertical direction of the vehicle. The reference value setting unit sets the reference value to a value that is different depending on the acceleration in each of the front-and-rear direction, the lateral direction, and the vertical direction of the vehicle acquired by the vehicle behavior information acquisition unit.

According to the configuration described above, by setting, by the reference value setting unit, the reference value to a value different depending on the acceleration in each of the front-and-rear direction, the lateral direction, and the vertical direction of the vehicle acquired by the vehicle behavior information acquisition unit, the duration can be counted in consideration of the direction of vehicle vibration, and thus the index value relating to the driving state of the driver can be more accurately calculated.

The driver state determination apparatus according to aspect 5 of the present invention further includes an alarm output unit that outputs an alarm signal when the determination unit determines that the driver is in the unconscious state.

According to the configuration described above, when the determination unit determines that the driver is in an unconscious state, it is possible to issue a warning to the driver or an emergency call to an external emergency center or the like, by outputting the alarm signal by the alarm output unit.

A driver state determination method according to an aspect of the present invention includes: acquiring behavior information of a vehicle; acquiring image information including a face of a driver; setting a reference value based on the acquired vehicle behavior information; calculating an index value relating to a driving state of the driver using duration of a state in which an amount of change in the acquired image information is equal to or less than the reference value; and determining that the driver is in an unconscious state when the calculated index value is equal to or greater than a threshold value.

According to the method described above, after the reference value is set based on the acquired vehicle behavior information, the index value relating to the driving state of the driver is calculated using the duration of the state in which the amount of change in the acquired image information is equal to or less than the reference value. Then, it is determined that the driver is in an unconscious state when the calculated index value is equal to or greater than the threshold value. As described above, by determining the unconscious state of the driver based on the duration of the state in which movement of the face of the driver or the like is equal to or less than the reference value, for example, even when the driver does not perform a sudden steering operation, the unconscious state of the driver can be detected. Furthermore, since it is determined whether or not the driver is in an unconscious state in consideration of the behavior information of the vehicle, the unconscious state of the driver can be determined with high accuracy.

In the driver state determination method according to an aspect of the present invention, in calculating the index value, as the amount of change in the image information, a deviation or variance in each of a lateral direction, a vertical direction, and a rotation direction of the face of the driver is obtained.

According to the method described above, by obtaining the deviation or variance in the lateral direction, the vertical direction, and the rotation direction of the face of the driver, the index value relating to the driving state of the driver can be accurately calculated.

In the driver state determination method according to the aspect of the present invention, in acquiring the vehicle behavior information, an acceleration in each of a front-and-rear direction, a lateral direction, and a vertical direction of the vehicle is acquired. In setting the reference value, the reference value is set to: a first reference value when the acquired acceleration in each of the front-and-rear direction, the lateral direction, and the vertical direction of the vehicle is less than a predetermined value determined for each of the accelerations in the front-and-rear direction, the lateral direction, and the vertical direction of the vehicle; and a second reference value greater than the first reference value continuously for a predetermined time when one of the acquired accelerations in the front-and-rear direction, the lateral direction, and the vertical direction of the vehicle is equal to or greater than the predetermined value.

According to the method described above, in setting the reference value, the reference value is set to the first reference value or the second reference value according to whether or not the acceleration in each of the front-and-rear direction, the lateral direction, and the vertical direction of the vehicle is less than a predetermined value determined for each of the accelerations in the front-and-rear direction, the lateral direction, and the vertical direction of the vehicle. With this configuration, the duration can be counted in consideration of a case where the direction of the face or the like changes due to vehicle vibration, and thus the index value relating to the driving state of the driver can be accurately calculated even when the driver is in an unconscious state.

In the driver state determination method according to the aspect of the present invention, in acquiring the vehicle behavior information, an acceleration in each of a front-and-rear direction, a lateral direction, and a vertical direction of the vehicle is acquired. In setting the reference value, the reference value is set to a value that is different depending on the acquired acceleration in each of the front-and-rear direction, the lateral direction, and the vertical direction of the vehicle.

According to the method described above, the duration can be counted in consideration of the direction of vehicle vibration by setting the reference value to a value different depending on the acquired acceleration in each of the front-and-rear direction, the lateral direction, and the vertical direction of the vehicle, and thus the index value relating to the driving state of the driver can be calculated more accurately.

The driver state determination method according the aspect of the present invention further includes outputting an alarm signal when it is determined that the driver is in the unconscious state.

According to the method described above, when it is determined that the driver is in an unconscious state, it is possible to issue a warning to the driver or an emergency call to an external emergency center or the like, by outputting the alarm signal.

A non-transitory computer-readable medium storing a driver state determination program according to an aspect of the present invention, when executed by a computer, causing the computer to function as each of units included in the driver state determination apparatus according to any one of aspects 1 to 6.

According to the driver state determination program described above, an unconscious state of a driver can be determined with high accuracy.

According to one embodiment of the present invention, an unconscious state of a driver can be grasped with high accuracy.

### BRIEF DESCRIPTION OF DRAWINGS

FIG. 1 is a block diagram illustrating a configuration of a driver state determination apparatus according to Embodiment 1 of the present invention.

FIG. 2 is an example of a table relating to count-up conditions stored in a storage unit of FIG. 1.

FIG. 3 is an example of a table relating to a reference value for count-up stored in the storage unit of FIG. 1.

FIG. 4 is an example of a table relating to count reset conditions stored in the storage unit of FIG. 1.

FIG. 5 is a flowchart illustrating a flow of a driver state determination method according to Embodiment 1.

FIG. 6 is a flowchart illustrating a flow of determining an unconscious state of a driver in FIG. 5.

FIG. 7 is an example of a table relating to a reference value for count-up stored in a storage unit of a driver state determination apparatus according to Embodiment 2 of the present invention.

FIG. 8 is an example of a table relating to alarm conditions stored in the storage unit of the driver state determination apparatus according to Embodiment 2.

FIG. 9 is a flowchart illustrating a flow of determining an unconscious state of a driver in a driver state determination method according to Embodiment 2 (part 1).

FIG. 10 is another flowchart illustrating the flow of determining the unconscious state of the driver in the driver state determination method according to Embodiment 2 (part 2).

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

### Embodiment 1

[Driver State Determination Apparatus]

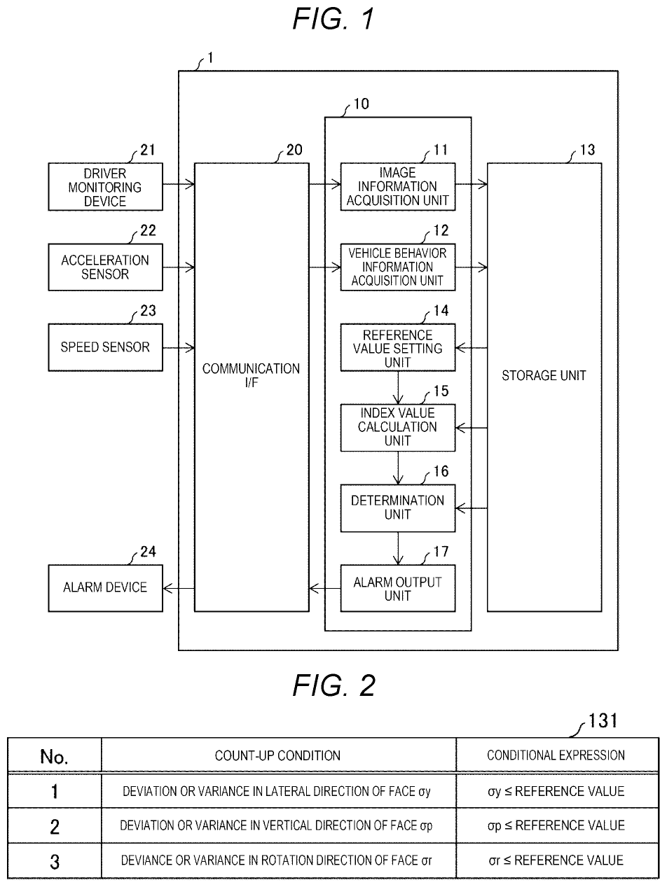

Hereinafter, a driver state determination apparatus 1 according to Embodiment 1 of the present invention will be described with reference to FIGS. 1 to 6. FIG. 1 is a block diagram illustrating a configuration of a driver state determination apparatus according to Embodiment 1. The driver state determination apparatus 1 is an apparatus that is mounted on a vehicle such as a passenger car and determines an unconscious state of a driver of the vehicle. In this embodiment, as the unconscious state, a state is assumed in which the driver loses consciousness due to sudden illness, falling asleep, and the like, and becomes rigid.

As illustrated in FIG. 1, the driver state determination apparatus 1 is configured such that a control unit 10, a storage unit 13, and a communication interface 20 are electrically connected. In FIG. 1, the communication interface is described as a communication I/F. As the communication interface 20, for example, a controller area network (CAN) communication is used. The driver state determination apparatus 1 is electrically connected to a driver monitoring device 21, an acceleration sensor 22, a speed sensor 23, an alarm device 24, and the like provided in the vehicle via a communication interface 20. The communication interface 20 may include an interface for wired communication or an interface for wireless communication.

The driver monitoring device 21 continuously captures a predetermined range including a face of a driver. The driver monitoring device 21 is installed at a position in front of the driver, for example, on a dashboard. The driver monitoring device 21 is an example of a sensor that monitors a driver. The driver monitoring device 21 outputs captured image information to the driver state determination apparatus 1.

A plurality of acceleration sensors 22 are installed at a front portion and a rear portion inside the vehicle, and are devices that detect acceleration in the front-and-rear direction, the lateral direction, and the vertical direction of the vehicle. The acceleration sensor 22 outputs acceleration information relating to magnitude of the acceleration in the front-and-rear direction, the lateral direction, and the vertical direction of the vehicle to the driver state determination apparatus 1.

The speed sensor 23 measures the speed of the vehicle. The speed sensor 23 outputs speed information relating to magnitude of the speed of the vehicle to the driver state determination apparatus 1.

The alarm device 24 is a device for providing assistance to the driver based on receiving an alarm signal from an alarm output unit 17. As the alarm device 24, for example, a speaker that issues warning or alerts to the driver, a navigation device, an emergency notification device that transmits an emergency signal to an external emergency center, or the like is used. The alarm device 24 may be any device that can provide assistance to the driver, and may also be, for example, a device that applies an external stimulus such as vibration to the driver.

The control unit 10 includes an image information acquisition unit 11, a vehicle behavior information acquisition unit 12, a reference value setting unit 14, an index value calculation unit 15, a determination unit 16, and an alarm output unit 17. The control unit 10 includes a central processing unit (CPU), a read only memory (ROM), a random access memory (RAM), and the like. The control unit 10 controls the operation of each unit of the driver state determination apparatus 1 based on receiving image information from the driver monitoring device 21, acceleration information from the acceleration sensor 22, speed information from the speed sensor 23, and the like.

The image information acquisition unit 11 acquires image information from the driver monitoring device 21 via the communication interface 20. The image information includes the direction of the face, the eye opening and closing operation, the movement of line of sight, the position of each organ of the face of the driver, and the like. The image information acquired by the image information acquisition unit 11 is transmitted to the storage unit 13.

The vehicle behavior information acquisition unit 12 acquires acceleration information from the acceleration sensor 22, speed information from the speed sensor 23, and the like as vehicle behavior information via the communication interface 20. The vehicle behavior information acquired by the vehicle behavior information acquisition unit 12 is transmitted to the storage unit 13.

The storage unit 13 is, for example, a hard disk drive (HDD). The storage unit 13 stores vehicle behavior information acquired by the vehicle behavior information acquisition unit 12, image information acquired by the driver monitoring device 21, and the like.

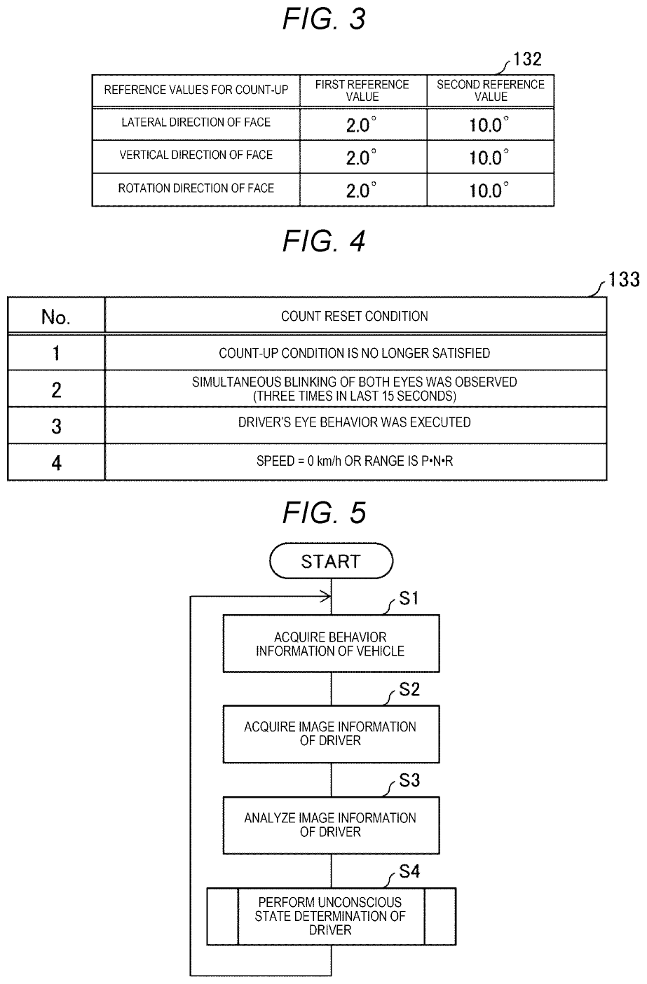

The storage unit 13 stores various condition tables and the like used for determination of an unconscious state of the driver described later. The various condition tables include a count-up condition table 131 illustrated in FIG. 2, a reference value for count-up table 132 illustrated in FIG. 3, a count reset condition table 133 illustrated in FIG. 4, and the like.

Here, the “count-up condition”, the “reference value for count-up”, and the “count reset condition” will be described. In the unconscious state determination of the driver in Embodiment 1, an index value relating to a driving state of the driver is calculated by counting the duration of a state in which an amount of change in the direction of the face of the driver is equal to or less than a reference value. This takes into consideration that a state in which the amount of change in the direction of the face of the driver continues to be extremely small in a state in which the driver loses consciousness due to sudden illness, falling asleep, or the like and becomes rigid.

This “count-up condition” is that all of the following three conditions are satisfied, as illustrated in the count-up condition table 131 in FIG. 2.

Condition 1. Deviation (or variance) in the lateral direction of the face σy≤reference value

Condition 2. Deviation (or variance) in the vertical direction of the face σp≤reference value

Condition 3. Deviation (or variance) in the rotation direction of the face σr≤reference value

In Embodiment 1, two reference values for count-up are set as a “first reference value” and a “second reference value”. Specifically, as illustrated in the reference value for count-up table 132 in FIG. 3, for example, the “first reference value” in the lateral direction of the face, the vertical direction of the face, and the rotation direction of the face is 2.0°, and the “second reference value” in the lateral direction of the face, the vertical direction of the face, and the rotation direction of the face is 10.0°. It is sufficient that the second reference value is greater than the first reference value, and different reference values may be used depending on the direction of the face.

In the unconscious state determination of the driver in Embodiment 1, when the “count reset condition” is satisfied, the count of the duration is reset. The “count reset condition” is to satisfy one of the following conditions as illustrated in the count reset condition table 133 in FIG. 4.

Condition 1. The count-up condition is no longer satisfied.

Condition 2. Blinking of the eyes of the driver was observed three times in the last 15 seconds.

Condition 3. Behavior of the eyes of the driver was executed.

Condition 4. Vehicle speed=0 [km/h], or the range is “P” (parking), “N” (neutral), “R” (reverse).

The reference value setting unit 14 acquires the behavior information of the vehicle from the storage unit 13, and sets the reference value of the count-up to the first reference value or the second reference value based on the behavior information of the vehicle (see FIG. 3). Specifically, the reference value setting unit 14 sets the reference value for count-up to the first reference value when the acceleration in each of the front-and-rear direction, the lateral direction, and the vertical direction of the vehicle is less than a predetermined value (for example, 0.1 G). The predetermined value may be a different value for each of the accelerations in the directions.

On the other hand, when the acceleration in any of the front-and-rear direction, the lateral direction, and the vertical direction of the vehicle is equal to or greater than a predetermined value (for example, 0.1 G), the reference value setting unit 14 sets the reference value for count-up to a second reference value greater than the first reference value for a prescribed time (for example, 8 seconds). This takes into account that even if the driver is in an unconscious state, if the vibration of the vehicle occurs, the direction of the face of the driver or the like changes.

The index value calculation unit 15 acquires image information acquired by the image information acquisition unit 11 from the storage unit 13 and analyzes the image information to calculate an index value relating to the driving state of the driver. Specifically, the index value calculation unit 15 analyzes the amount of change in the image information of the driver, such as changes in the lateral direction, vertical direction, and rotation direction of the face, the eye opening and closing operation, and the direction of line of sight of the driver.

Then, the index value calculation unit 15 calculates an index value relating to the driving state of the driver by using the duration of the state in which the amount of change in the image information is equal to or less than the reference value. Specifically, the index value calculation unit 15 increases the index value according to the duration of the state in which the count-up condition is satisfied and the count reset condition is not generated. At this time, the index value calculation unit 15 uses information on the reference value set by the reference value setting unit 14.

The determination unit 16 determines whether or not the driver is in the unconscious state, by using the index value calculated by the index value calculation unit 15 and a threshold value stored in the storage unit 13 in advance. That is, the determination unit 16 determines that the driver is in the unconscious state when the index value is equal to or greater than the threshold value. A personal identification device for identifying a driver may be provided in the driver state determination apparatus 1, and a different threshold value may be provided for each driver.

The alarm output unit 17 outputs an alarm signal to the alarm device 24 via the communication interface 20 when the determination unit 16 determines that the driver is in the unconscious state. The alarm device 24 supports the driver based on receiving the alarm signal from the alarm output unit 17 as described above.

[Driver State Determination Method]

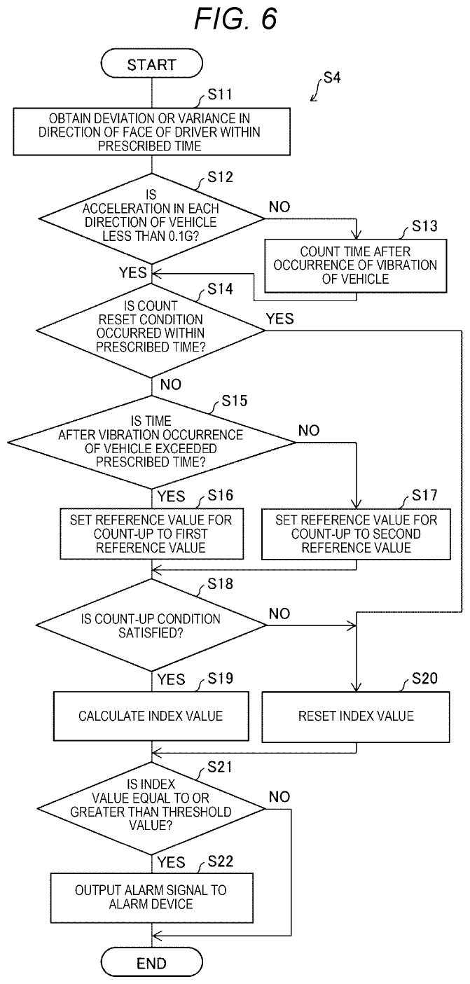

Next, a driver state determination method by the driver state determination apparatus 1 according to Embodiment 1 will be described with reference to the flowcharts of FIGS. 5 and 6. The flowcharts in FIGS. 5 and 6 are examples, and are not limited to thereto.

FIG. 5 is a flowchart illustrating a flow of the driver state determination method according to Embodiment 1. First, the vehicle behavior information acquisition unit 12 of the control unit 10 acquires vehicle behavior information (S1) (vehicle behavior information acquisition step). Specifically, the vehicle behavior information acquisition unit 12 acquires acceleration information in the front-and-rear direction, lateral direction, and vertical direction of the vehicle from the acceleration sensor 22, vehicle speed information from the speed sensor 23, and the like, as the behavior information of the vehicle.

Subsequently, the image information acquisition unit 11 of the control unit 10 acquires image information including the face of the driver (S2) (image information acquisition step). Specifically, the image information acquisition unit 11 acquires the image information of the driver such as the face direction, the opening and closing operation of the eyes, and the line of sight direction of the driver from the driver monitoring device 21.

The index value calculation unit 15 of the control unit 10 analyzes the acquired image information of the driver (S3). Specifically, the index value calculation unit 15 analyzes changes in the image information of the driver, such as changes in the lateral direction, vertical direction, and rotation direction of the face, the opening and closing operation of the eyes, and the line of sight direction of the driver. Then, the control unit 10 performs the unconscious state determination of the driver illustrated in FIG. 6 (S4). In the driver state determination method by the driver state determination apparatus 1 of Embodiment 1, processing of S1 to S4 is repeatedly performed at prescribed time intervals (for example, for 0.1 seconds).

FIG. 6 is a flowchart illustrating a flow of determining an unconscious state of a driver. In the unconscious state determination of the driver illustrated in FIG. 6, first, the index value calculation unit 15 of the control unit 10 obtains a deviation (or variance) in each direction of the face of the driver within a prescribed time (for example, 8 seconds) based on the analysis result of the image information of the driver (S11).

Subsequently, the reference value setting unit 14 determines whether or not the magnitude of the acceleration in each of the front-and-rear direction, the lateral direction, and the vertical direction of the vehicle is less than a predetermined value (for example, 0.1 G), using the behavior information of the vehicle acquired in S1 (S12). When it is determined that the magnitude of the acceleration in each direction of the vehicle is not less than the predetermined value (NO in S12), that is, when any of the acceleration of the vehicle in the front-and-rear direction, the lateral direction, and the vertical direction of the vehicle is not less than the predetermined value, the reference value setting unit 14 counts the time after the occurrence of the vibration of the vehicle (S13).

When it is determined that the magnitude of the acceleration in each direction of the vehicle is less than the predetermined value (YES in S12), or after S13, the reference value setting unit 14 determines whether or not a count reset condition has occurred within a prescribed time (for example, 8 seconds) (S14).

When it is determined that the count reset condition has not occurred within the prescribed time (NO in S14), the reference value setting unit 14 determines whether or not the time after the occurrence of the vibration of the vehicle exceeds the prescribed time (for example, 8 seconds) (S15). When it is determined that the time after the occurrence of the vibration of the vehicle exceeds the prescribed time (YES in 15), the reference value setting unit 14 sets the reference value for count-up to the first reference value (S16), and when the time after the occurrence of the vibration of the vehicle is equal to or less than the prescribed time (NO YES in 15), the reference value setting unit 14 sets the reference value for count-up to the second reference value (S17).

Subsequently, the index value calculation unit 15 of the control unit 10 determines whether or not the count-up condition is satisfied (S18). When it is determined that the count-up condition is satisfied (YES in S18), the index value calculation unit 15 performs an index value calculation step of calculating an index value (S19).

On the other hand, when it is determined that the count reset condition has occurred within the prescribed time (YES in S14), or when it is determined that the count-up condition is not satisfied (NO in S18), the index value calculation unit 15 resets the index value (S20). For example, when the behavior of the eyes of the driver is present, when any of the deviations (or variances) in each direction of the face becomes greater than a reference value, or when the vehicle is parked, the index value is reset. With this configuration, erroneous detection of the unconscious state of the driver is prevented.

Then, the determination unit 16 determines whether or not the index value calculated by the index value calculation unit 15 is equal to or greater than the threshold value (S21) (determination step). When it is determined that the index value is equal to or greater than the threshold value (YES in S21), the determination unit 16 determines that the driver is in an unconscious state and outputs an alarm signal to the alarm device 24 (S22). When it is determined that the index value is smaller than the threshold value (NO in S21), or after S22, the determination unit 16 ends the unconscious state determination of the driver (S4), and returns to S1.

According to the driver state determination method by the driver state determination apparatus 1 of Embodiment 1 described above, after the reference value setting unit 14 sets the reference value based on the vehicle behavior information acquired by the vehicle behavior information acquisition unit 12, the index value relating to the driving state of the driver is calculated by the index value calculation unit 15 using the duration of the state in which the amount of change in the image information acquired by image information acquisition unit 11 is equal to or less than the reference value. Then, the determination unit 16 determines that the driver is in an unconscious state when the index value calculated by the index value calculation unit is equal to or greater than the threshold value. As described above, by determining the unconscious state of the driver based on the duration of the state in which movement of the face of the driver or the like is equal to or less than the reference value, for example, even when the driver does not perform a sudden steering operation, the unconscious state of the driver can be detected. Furthermore, by determining whether or not the driver is in an unconscious state in consideration of the behavior information of the vehicle in addition to the duration, the unconscious state of the driver can be determined with high accuracy.

Since the reference value setting unit 14 sets the reference value to the first reference value or the second reference value according to whether or not the acceleration in each of the front-and-rear direction, the lateral direction, and the vertical direction of the vehicle is less than a predetermined value, even when the driver is in an unconscious state, the duration can be counted in consideration of the case where the direction of the face changes due to vehicle vibration. With this configuration, the index value relating to the driving state of the driver can be accurately calculated.

When the determination unit 16 determines that the driver is in an unconscious state, it is possible to issue a warning to the driver or an emergency call to an external emergency center or the like, by outputting an alarm signal by the alarm output unit 17.

### Embodiment 2

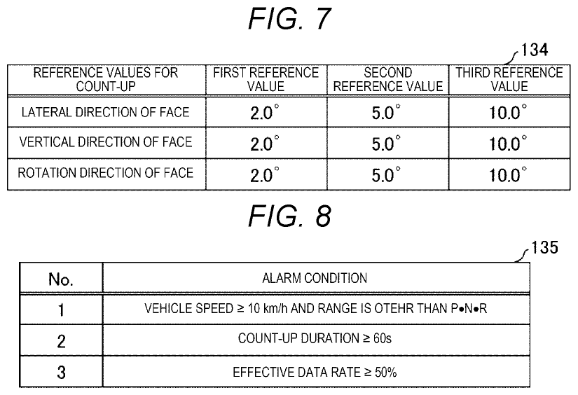

The driver state determination apparatus 1 according to Embodiment 2 of the present invention will be described with reference to FIGS. 7 to 10. For convenience of description, members having the same functions as those described in Embodiment 1 are denoted by the same reference numerals, and description thereof will not be repeated.

In Embodiment 2, three reference values for counting up are set as a “first reference value”, a “second reference value”, and a “third reference value”. Specifically, as illustrated in the reference value for count-up table 134 in FIG. 7, for example, the “first reference value” in the lateral direction of the face, the vertical direction of the face, and the rotation direction of the face is 2.0°, the “second reference value” in each direction of the face is 5.0°, and the “third reference value” in each direction of the face is 10.0°. It is sufficient that the second reference value and the third threshold value are greater than the first reference value, and different reference values may be used depending on the direction of the face.

In Embodiment 2, the index value calculation unit 15 calculates an index value in consideration of an “effective data rate” and an “alarm condition”. Here, the “effective data rate” refers to a ratio of time during which both of the following two conditions are satisfied as effective data conditions within a predetermined time (for example, within 60 seconds).

Condition 1. All deviations (or variances) in each face direction have been calculated.

Condition 2. Acceleration in each direction of the vehicle is less than a predetermined value (for example, 0.1 G) within a prescribed time (for example, 8 seconds).

The effective data condition is merely an example, and the present invention is not limited to this. For example, the acceleration in the vertical direction of the vehicle may not be included in the effective data condition. Instead of the acceleration in the vertical direction of the vehicle, presence or absence of a spin state of wheels may be included in the effective data condition.

FIG. 8 is an example of a table 135 relating to the alarm condition stored in the storage unit 13 of the driver state determination apparatus 1 according to Embodiment 2. The “alarm condition” means that the following three conditions are all satisfied, as illustrated in the table 135 relating to the alarm condition in FIG. 8.

Condition 1. Vehicle speed≥10 [km/h] and range is other than “P” (parking), “N” (neutral), and “R” (reverse).

Condition 2. Count-up duration is 60 seconds or more.

Condition 3. Effective data rate≥50%

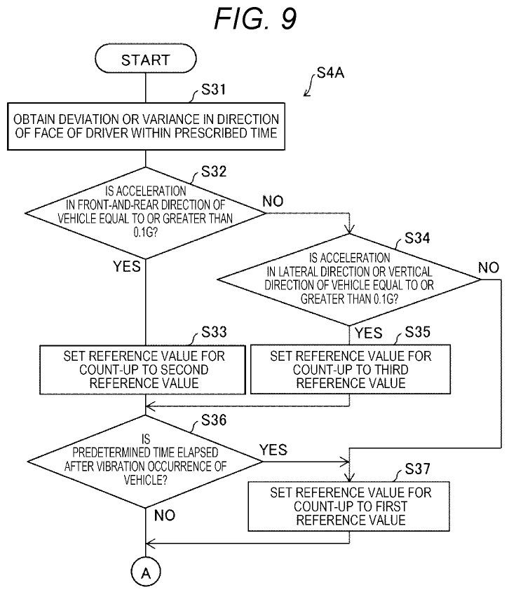

FIG. 9 is a flowchart illustrating a flow of determining an unconscious state of a driver in the driver state determination method according to Embodiment 2. In Embodiment 2, the unconscious state of the driver illustrated in FIG. 6 is determined (S4A).

The index value calculation unit 15 of the control unit 10 obtains the deviation (or variance) in each direction of the face of the driver within a prescribed time (for example, 8 seconds) based on the analysis result of the image information of the driver (S31). Subsequently, the reference value setting unit 14 determines whether or not the magnitude of the acceleration in the front-and-rear direction of the vehicle is equal to or greater than a predetermined value (for example, 0.1 G) using the behavior information of the vehicle acquired in S31 (S32).

When it is determined that the magnitude of the acceleration in the front-and-rear direction of the vehicle is equal to or greater than the predetermined value (YES in S32), the reference value setting unit 14 sets the reference value for count-up to the second reference value (S33).

When it is determined that the magnitude of the acceleration in the front-and-rear direction of the vehicle is less than the predetermined value (NO in S32), the reference value setting unit 14 determines whether or not the magnitude of the acceleration in the lateral direction or the vertical direction of the vehicle is equal to or greater than a predetermined value (for example, 0.1 G) (S34).

When it is determined that the magnitude of the acceleration in the lateral direction or the vertical direction of the vehicle is equal to or greater than the predetermined value (YES in S34), the reference value setting unit 14 sets the reference value for count-up to the third reference value (S35). After S33 or S35, the reference value setting unit 14 determines whether or not a predetermined time (for example, 8 seconds) has elapsed after the occurrence of the vibration of the vehicle (S36).

When it is determined that the magnitude of the acceleration in the lateral direction or the vertical direction of the vehicle is less than the predetermined value (NO in S34), or when it is determined that a predetermined time (for example, 8 seconds) has elapsed after the occurrence of the vibration of the vehicle (YES in S36), the reference value setting unit 14 sets the reference value for count-up to the first reference value (S37). S33, S35, and S37 correspond to a threshold value setting step.

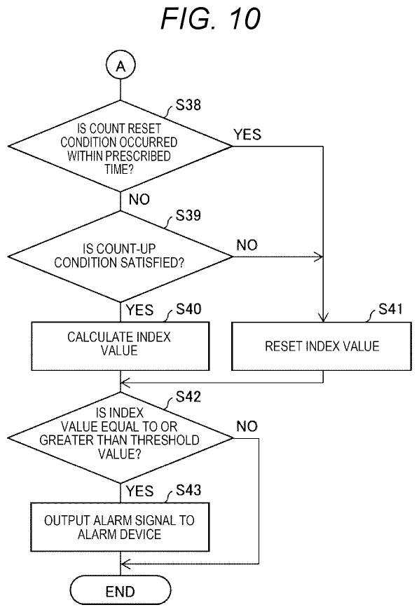

When it is determined that the elapsed time after the occurrence of the vibration of the vehicle is less than the predetermined time (NO in S36), or after S37, the process proceeds to S38 in the flowchart of FIG. 10. In S38, the index value calculation unit 15 determines whether or not a count reset condition has occurred within a prescribed time (for example, 8 seconds) (S38).

When it is determined that the count reset condition has not occurred within the prescribed time (NO in S38), the index value calculation unit 15 determines whether or not the count-up condition is satisfied (S39). When it is determined that the count-up condition is satisfied (YES in S39), the index value calculation unit 15 performs an index value calculation step of calculating an index value (S40).

Specifically, the index value calculation unit 15 calculates the index value according to the degree to which three conditions of the condition 1, the condition 2, and the condition 3 illustrated in the table 135 relating to the alarm condition in FIG. 8 are satisfied.

On the other hand, when it is determined that the count-up condition is not satisfied (NO in S39), the index value calculation unit 15 resets the index value (S41).

Then, the determination unit 16 performs a determination step of determining whether or not the index value is equal to or greater than the threshold value (S42). When it is determined that the index value is equal to or greater than the threshold value (YES in S42), an alarm output step of outputting an alarm signal to the alarm device 24 is performed (S43). When it is determined that the index value is less than the threshold value (NO in S42), or after S43, the unconscious state determination of the driver (S4A) ends, and the process returns to S1 in FIG. 1.

The same effect as in Embodiment 1 can be obtained also by the driver state determination method by the driver state determination apparatus 1 of Embodiment 2 described above. In particular, the duration can be counted in consideration of the direction of the vehicle vibration by setting three different reference values by the reference value setting unit 14 according to the acceleration in each of the front-and-rear direction, lateral direction and the vertical direction of the vehicle, and thus the index value relating to the driving state of the driver can be calculated more accurately.

Since the index value calculation unit 15 calculates the index value in consideration of the effective data rate and the alarm condition, it is possible to reduce the possibility that the unconscious state of the driver is erroneously detected. That is, for example, when all the deviations (or variances) of the faces in the respective directions have not been calculated by the index value calculation unit 15, the effective data rate becomes low and the index value becomes a low value. With this configuration, it is possible to prevent the unconscious state of the driver from being erroneously detected even though the state of each direction of the face has not been sufficiently analyzed. For example, by setting the index value to a low value when the state in which the vehicle vibration is 0.1 or more continues for a prescribed time or more, erroneous detection of the unconscious state of the driver can be prevented.

### Other Embodiments

In the embodiments described above, the index value calculation unit 15 of the control unit 10 calculates the deviation (or variance) of each direction of the face of the driver within a prescribed time based only on the analysis result of the image information of the driver, but is not limited thereto. For example, a personal identification device that specifies a driver may be provided in the driver state determination apparatus 1, and when the driver is specified by the individual identification device, the index value calculation unit 15 may calculate the deviation (or variance) in each direction of the face of the driver corrected in consideration of the personal characteristics and the like stored in the storage unit 13 in advance.

[Example of Software Implementation]

Each functional block of the control unit 10 may be implemented by a logic circuit (hardware) formed in an integrated circuit (IC chip) or the like, or may be implemented by software.

In the latter case, a computer that executes instructions of a driver state determination program, which is software that implements the functions of the respective units (image information acquisition unit 11, vehicle behavior information acquisition unit 12, reference value setting unit 14, index value calculation unit 15, determination unit 16, and alarm output unit 17) of the control unit 10, may be provided. The computer includes, for example, at least one processor and at least one computer-readable recording medium storing the driver state determination program. In the computer, the object of one or more embodiments of the present invention is achieved when the processor reads the driver state determination program from the recording medium and executes the program. As the processor, for example, a central processing unit (CPU) can be used. As the recording medium, a “non-transitory tangible medium” for example, a read only memory (ROM), a tape, a disk, a card, a semiconductor memory, and a programmable logic circuit can be used. A random access memory (RAM) for developing the driver state determination program may be further provided. The program may be supplied to the computer via an arbitrary transmission medium (a communication network, a broadcast wave, or the like) capable of transmitting the program. One embodiment of the present invention can also be implemented in the form of a data signal embedded in a carrier wave, in which the driver state determination program is embodied by electronic transmission.

The present invention is not limited to the embodiments described above, and various modifications may be made within the scope set forth in the claims, and embodiments obtained by appropriately combining technical means disclosed in different embodiments are also included in the technical scope of the present invention.

1. A driver state determination apparatus comprising:
a vehicle behavior information acquisition unit that acquires behavior information of a vehicle;
an image information acquisition unit that acquires image information including a face of a driver;
a reference value setting unit that sets a reference value based on the behavior information of the vehicle acquired by the vehicle behavior information acquisition unit;
an index value calculation unit that calculates an index value relating to a driving state of the driver using duration of a state in which an amount of change in the image information acquired by the image information acquisition unit is equal to or less than the reference value; and
a determination unit that determines that the driver is in an unconscious state when the index value calculated by the index value calculation unit is equal to or greater than a threshold value.

2. The driver state determination apparatus according to claim 1,
wherein the index value calculation unit obtains, as the amount of change in the image information, a deviation or variance in each of a lateral direction, a vertical direction, and a rotation direction of the face of the driver.

3. The driver state determination apparatus according to claim 1,
wherein the vehicle behavior information acquisition unit acquires an acceleration in each of a front-and-rear direction, a lateral direction, and a vertical direction of the vehicle, and
wherein the reference value setting unit sets the reference value to:
a first reference value when the acceleration in each of the front-and-rear direction, the lateral direction, and the vertical direction of the vehicle acquired by the vehicle behavior information acquisition unit is less than a predetermined value determined for each of the accelerations in the front-and-rear direction, the lateral direction, and the vertical direction of the vehicle, and
a second reference value greater than the first reference value continuously for a predetermined time when any one of the accelerations in the front-and-rear direction, the lateral direction, the vertical direction of the vehicle acquired by the vehicle behavior information acquisition unit is equal to or greater than the predetermined value.

4. The driver state determination apparatus according to claim 1,
wherein the vehicle behavior information acquisition unit acquires an acceleration in each of a front-and-rear direction, a lateral direction, and a vertical direction of the vehicle, and
wherein the reference value setting unit sets the reference value to a value that is different depending on the acceleration in each of the front-and-rear direction, the lateral direction, and the vertical direction of the vehicle acquired by the vehicle behavior information acquisition unit.

5. The driver state determination apparatus according to claim 1, further comprising:
an alarm output unit that outputs an alarm signal when the determination unit determines that the driver is in the unconscious state.

6. A driver state determination method comprising:
acquiring behavior information of a vehicle;
acquiring image information including a face of a driver;
setting a reference value based on the acquired vehicle behavior information;
calculating an index value relating to a driving state of the driver using duration of a state in which an amount of change in the acquired image information is equal to or less than the reference value; and
determining that the driver is in an unconscious state when the calculated index value is equal to or greater than a threshold value.

7. The driver state determination method according to claim 6,
in calculating the index value, as the amount of change in the image information, a deviation or variance in each of a lateral direction, a vertical direction, and a rotation direction of the face of the driver is obtained.

8. The driver state determination method according to claim 6,
wherein in acquiring the vehicle behavior information, an acceleration in each of a front-and-rear direction, a lateral direction, and a vertical direction of the vehicle is acquired, and
wherein in setting the reference value, the reference value is set to:
a first reference value when the acquired acceleration in each of the front-and-rear direction, the lateral direction, and the vertical direction of the vehicle is less than a predetermined value determined for each of the accelerations in the front-and-rear direction, the lateral direction, and the vertical direction of the vehicle, and
a second reference value greater than the first reference value continuously for a predetermined time when any one of the acquired accelerations in the front-and-rear direction, the lateral direction, and the vertical direction of the vehicle is equal to or greater than the predetermined value.

9. The driver state determination method according to claim 6,
wherein in acquiring the vehicle behavior information, an acceleration in each of the front-and-rear direction, a lateral direction, and a vertical direction of the vehicle is acquired, and
wherein in setting the reference value, the reference value is set to a value that is different depending on the acquired acceleration in each of the front-and-rear direction, the lateral direction, and the vertical direction of the vehicle.

10. The driver state determination method according to claim 6, further comprising:
outputting an alarm signal when it is determined that the driver is in the unconscious state.

11. A non-transitory computer-readable medium storing a driver state determination program, when executed by a computer, causing the computer to function as each of the units included in the driver state determination apparatus according to claim 1.
